(19) United States
(12) Patent Application Publication
(10) Pub. No.: US 2025/0372900 A1
(43) Pub. Date: Dec. 4, 2025

(54) TERMINAL BLOCK

(71) Applicant: Yazaki Corporation, Tokyo (JP)

(72) Inventors: Yasuhiro TANAKA, Shizuoka (JP); Yasuhiro OTSUTA, Shizuoka (JP); Masatoshi YAMADA, Shizuoka (JP); Shogo FURUI, Shizuoka (JP); Kohei MATSUURA, Shizuoka (JP)

(73) Assignee: Yazaki Corporation, Tokyo (JP)

(21) Appl. No.: 19/198,353

(22) Filed: May 5, 2025

(30) Foreign Application Priority Data
May 28, 2024 (JP) 2024-086086

(51) Int. Cl. H01R 9/24

(52) U.S. Cl. CPC H01R 9/24; H01R 2201/26

(57) ABSTRACT

A terminal block is configured to include: a housing that holds a terminal; and a water stop member that is accommodated in a groove portion formed on the housing and stops water between the housing and an attachment target, in which the water stop member includes a main body having an annular shape, a locking portion that protrudes from a side portion of the main body and is engaged with the housing, and a protrusion that protrudes from the side portion of the main body and contacts the groove portion.

### CROSS-REFERENCE TO RELATED APPLICATION(S)

The present application claims priority to and incorporates by reference the entire contents of Japanese Patent Application No. 2024-086086 filed in Japan on May 28, 2024.

### BACKGROUND OF THE INVENTION

### 1. Field of the Invention

The present invention relates to a terminal block.

### 2. Description of the Related Art

Conventionally, as a terminal block, for example, as described in JP 2010-211 933 A, a terminal block in which a terminal is held by a housing and the housing is attached to an attachment target (adherend) by a fastening member is known. In this terminal block, a peripheral groove is provided on a surface of the housing facing the attachment target, and a water stop member is fitted in the peripheral groove to stop water between the housing and the attachment target.

Such a terminal block has room for improvement in that it is difficult to reduce the size. For example, in the above-described terminal block, a positioning piece protruding to the outside of the water stop member is formed. Therefore, the water stop member becomes large, which hinders a reduction in size of the terminal block. On the other hand, in order to bring the water stop member into contact with a side surface of the peripheral groove, it is conceivable to form a protrusion protruding from a side portion of the water stop member. However, when such a protrusion is provided, the water stop member is compressed and the peripheral groove is strongly pressed when the housing is attached to the attachment target.

### SUMMARY OF THE INVENTION

Therefore, an object of the present invention is to provide a terminal block capable of reducing the pressing force of the water stop member against the housing and reducing the size of the terminal block.

In order to achieve the above mentioned object, a terminal block according to one aspect of the present invention includes a housing that holds a terminal; and a water stop member that is accommodated in a groove portion formed on the housing and stops water between the housing and an attachment target, wherein the water stop member includes a main body having an annular shape, a locking portion that protrudes from a side portion of the main body and is engaged with the housing, and a protrusion that protrudes from the side portion of the main body and contacts the groove portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is a perspective view of the terminal block according to the embodiment;

FIG. 3 is an exploded perspective view of the terminal block according to the embodiment;

FIG. 4 is an explanatory view of a water stop member of the terminal block according to the embodiment, and is a front view of the terminal block as viewed from IV-IV in FIG. 1;

FIG. 5 is an explanatory view of a locking portion in the water stop member of the terminal block according to the embodiment;

FIG. 6 is an explanatory view of a protrusion in the water stop member of the terminal block according to the embodiment;

FIG. 7 is an explanatory view of a terminal block of a comparative example; and

FIG. 8 is an explanatory view of a terminal block of a comparative example.

### DETAILED DESCRIPTION OF THE PREFERRED EMBODIMENTS

Hereinafter, an embodiment according to the present invention will be described in detail with reference to the drawings. Note that the present invention is not limited to this embodiment. In addition, the constituent elements in the embodiment described below include those that can be easily replaced by those skilled in the art or those that are substantially the same.

### EMBODIMENT

The present embodiment relates to a terminal block. In the description below, among a first direction, a second direction, and a third direction intersecting one another, the first direction is referred to as an “attachment direction X”, the second direction is referred to as a “width direction Y”, and the third direction is referred to as a “height direction Z”. Here, the attachment direction X, the width direction Y, and the height direction Z are orthogonal to one another. Note that orthogonal as used herein includes substantially orthogonal. The attachment direction X corresponds to a direction in which the housing is attached to the attachment target. In addition, each direction used in the following description represents a direction in a state in which each part is assembled to each other unless otherwise specified.

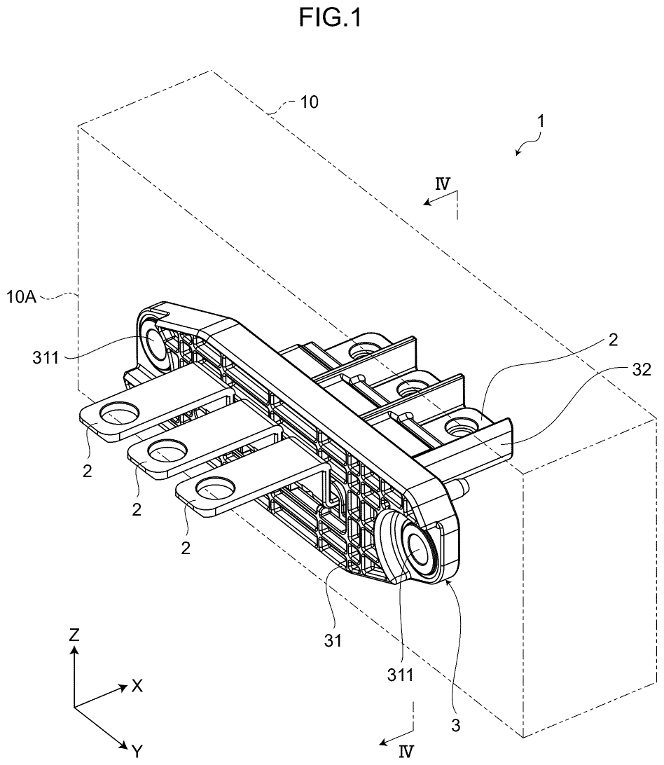

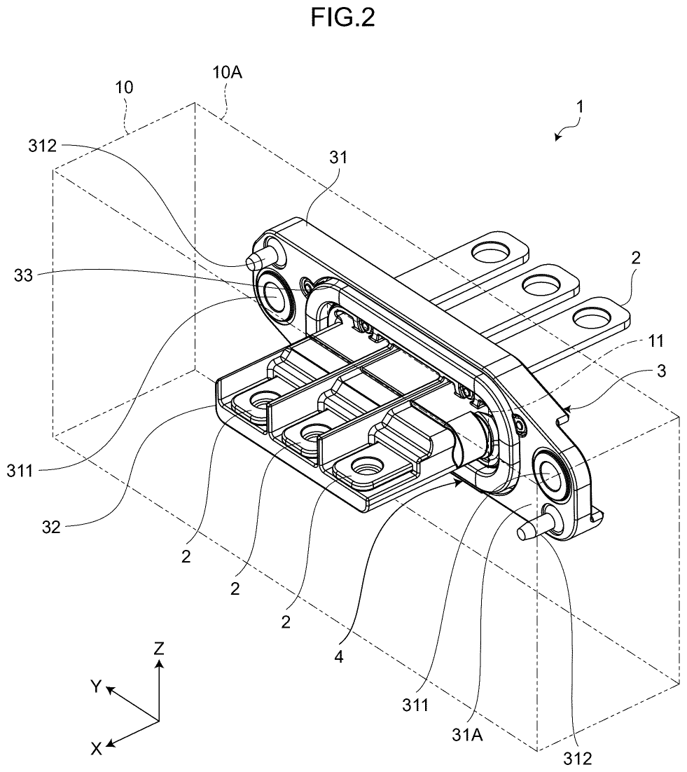

As illustrated in FIGS. 1 to 3, a terminal block 1 is a part that holds terminals 2, and is used by being attached to an attachment target 10. The terminal block 1 is mounted on a vehicle, for example, and holds the plurality of terminals 2 arranged along the width direction Y. The attachment target 10 is a vehicle unit mounted on the vehicle or provided on the vehicle, and corresponds to, for example, a component of the vehicle, or a part, a member, or a device mounted on the vehicle and so on. In FIGS. 1 and 2, the attachment target 10 is illustrated as a rectangular parallelepiped for convenience of description, but the shape and structure of the attachment target 10 are not limited thereto. The terminal block 1 includes the terminals 2, a housing 3, and a water stop member 4.

The housing 3 is a part that holds the terminals 2 and is fitted to the attachment target 10, and is configured such that, for example, a protrusion portion 32 is provided to protrude from a main body portion 31. The main body portion 31 has a plate shape, is disposed so as to face an attachment surface 10A of the attachment target 10, and is attached to the attachment target 10. The main body portion 31 is, for example, a rectangular plate body that is longer in the width direction Y than in the height direction Z. Note that the rectangle also includes a substantially rectangular shape. The protrusion portion 32 protrudes along the attachment direction X from a surface of the main body portion 31 facing the attachment target 10. The protrusion portion 32 is inserted into a fitting portion 11 formed in the attachment target 10 when the terminal block 1 is attached to the attachment target 10. The fitting portion 11 is a hole formed in the attachment target 10, and is formed by recessing the attachment surface 10A.

Attachment holes 311 and projections 312 are formed on the housing 3. The attachment hole 311 is a hole used for attaching the housing 3 to the attachment target 10, and is formed so as to penetrate the main body portion 31 along the attachment direction X. A fastening member, which is not illustrated, is inserted into the attachment hole 311. That is, the housing 3 is fixed to the attachment target 10 by inserting the fastening member into the attachment hole 311 and screwing the fastening member into the attachment target 10. The projection 312 is a projection body protruding from an attachment surface 31A of the main body portion 31 in the attachment direction X. The projection 312 functions as a member that positions the attachment position of the housing 3. For example, one attachment hole 311 and one projection 312 are provided at each of positions sandwiching the terminals 2.

The terminal 2 is a member formed of a conductive member, and for example, a plate-shaped terminal fitting is used. The terminal 2 is provided in the attachment direction X and penetrates the main body portion 31 along the attachment direction X. That is, the main body portion 31 holds the terminals 2 penetrating in the attachment direction X. A plurality of terminals 2 is provided, and for example, three terminals 2 are provided side by side along the width direction Y. The terminal 2 is formed to be bent in a crank shape, for example. Specifically, the terminal 2 is formed by being bent in the height direction Z from the attachment direction X and bent in the attachment direction X from the height direction Z. A portion of the terminal 2 bent in the height direction z contacts the surface of the main body portion 31, and a portion bent from the height direction Z in the attachment direction X penetrates the main body portion 31 and is disposed along the protrusion portion 32.

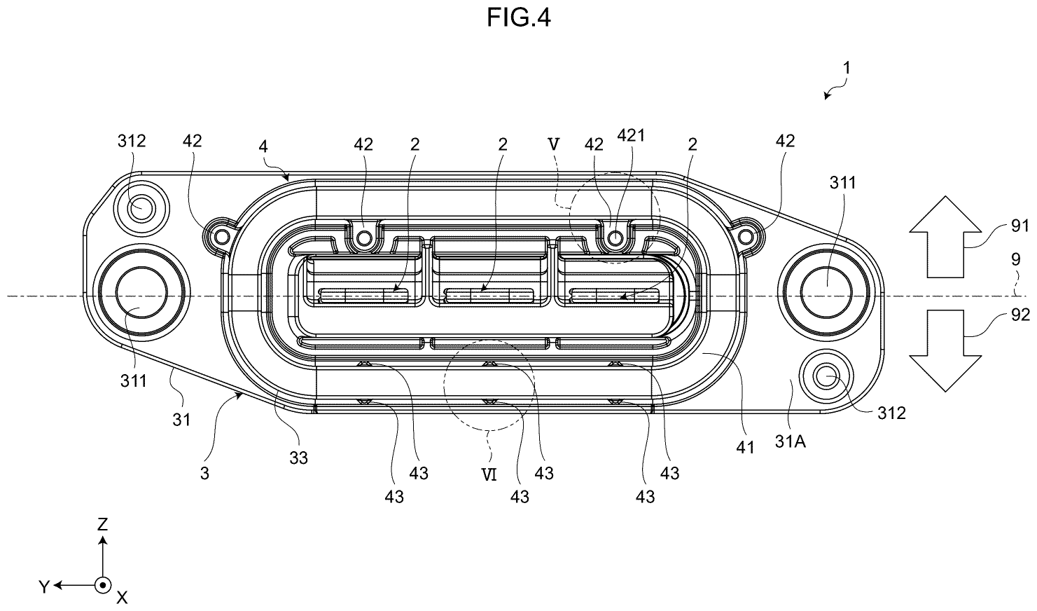

As illustrated in FIG. 4, the water stop member 4 is a member for stopping water between the housing 3 and the attachment target 10, and is formed of an annular elastic member. The water stop member 4 has, for example, a rectangular frame shape, and is attached to the housing 3 so as to enclose the terminals 2. The water stop member 4 is accommodated in a groove portion 33 formed on the housing 3 and attached to the housing 3. The groove portion 33 is a groove formed by recessing the attachment surface 31A of the main body portion 31 in the attachment direction X, and is formed to enclose the terminals 2, for example.

The water stop member 4 includes a main body 41, locking portions 42, and protrusions 43. The main body 41 is a portion that is formed in a rectangular frame shape and has a function to stop water in contact with the groove portion 33 of the housing 3 and the attachment target 10. Specifically, the main body 41 is formed in a rectangular frame shape with curved corners.

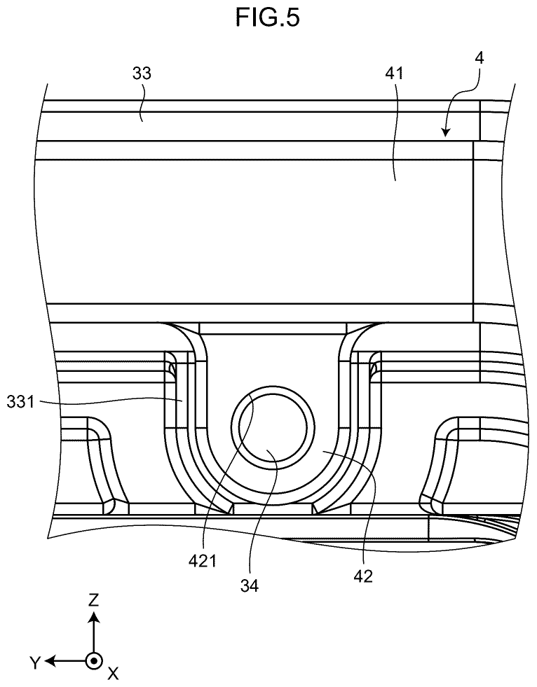

As illustrated in FIG. 5, the locking portion 42 is a portion that protrudes from a side portion of the main body 41 and engages with the housing 3. FIG. 5 is an enlarged view of a portion of V illustrated in FIG. 4. For example, a plurality of the locking portions 42 protrudes from an inner surface and an outer surface of the side portion of the main body 41, is provided at intervals along the extending direction of the water stop member 4, and is engaged with pins 34 formed on the housing 3. The pin 34 is a rod-shaped portion protruding from the attachment surface 31A of the main body portion 31 of the housing 3 in the attachment direction X. The locking portion 42 forms a through-hole 421 penetrating along the attachment direction X, and the pin 34 is inserted into the through-hole 421 to be engaged with the housing 3. The movement of the water stop member 4 in the extending direction is restricted by the engagement of the locking portions 42 with the housing 3. In addition, the water stop member 4 can be attached to a desired position with respect to the groove portion 33 by forming the locking portions 42.

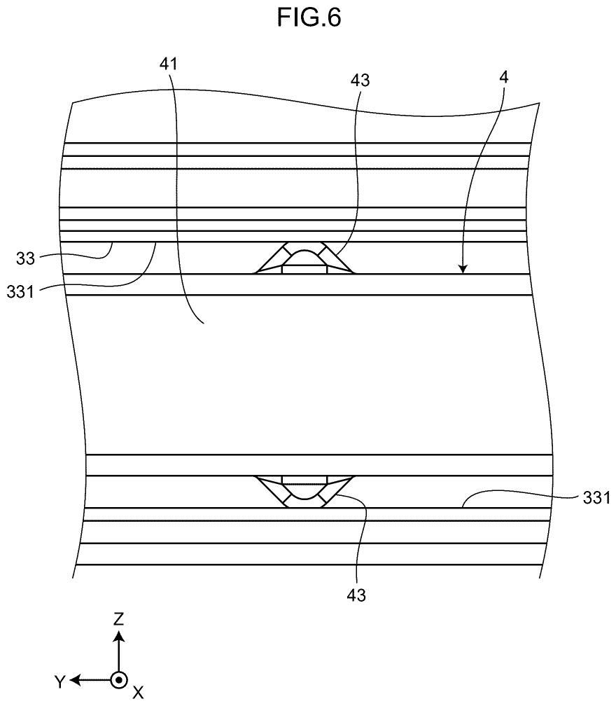

As illustrated in FIG. 6, the protrusions 43 are portions that protrude from a side portion of the main body 41 and contact the groove portion 33. FIG. 6 is an enlarged view of a portion of VI illustrated in FIG. 4. For example, a plurality of the protrusions 43 protrudes from an inner surface and an outer surface of the side portion of the main body 41, and is provided at intervals along the extending direction of the water stop member 4. The protrusions 43 contact a sidewall 331 of the groove portion 33 to restrict the movement of the water stop member 4 in the groove portion 33. Therefore, the protrusions 43 suppress deterioration of the water stop function of the water stop member 4 due to movement or deformation of the water stop member 4.

In FIG. 4, when the water stop member 4 is divided into two regions relative to a boundary line 9, the locking portions 42 are provided in one of the two regions, and the protrusions 43 are provided in the other of the two regions. The boundary line 9 is a virtual line for setting the two regions, and is set to pass through the installation position of the terminals 2, for example. Specifically, when the boundary line 9 passes through the installation position of the terminals 2 and is set along the width direction Y, the water stop member 4 is divided into a first region 91 and a second region 92 relative to the boundary line 9. That is, in the water stop member 4, the first region 91 and the second region 92 are different regions. The locking portions 42 are formed in the first region 91 of the water stop member 4, and the protrusions 43 are formed in the second region 92 of the water stop member 4. As described above, the terminal block 1 can be reduced in size while reducing the pressing force of the water stop member 4 against the housing 3 by disposing the locking portions 42 and the protrusions 43 in different regions.

In addition, when the attachment surface 10A of the attachment target 10 is a vertical surface, a substantially vertical surface, or a surface inclined from a horizontal surface, the first region 91 is an upper region of the water stop member 4, and the second region 92 is a lower region of the first region 91. In this case, the locking portions 42 are formed in the first region 91 in the upper portion of the water stop member 4, and the protrusions 43 are formed in the second region 92 in the lower portion of the water stop member 4. In this case, the terminal block 1 can reduce the pressing force of the water stop member 4 against the housing 3 while enhancing the water stop function of the water stop member 4. That is, in the terminal block 1, by forming the protrusions 43 for enhancing the water stop function in the second region 92 in the lower portion, even when water is accumulated around the lower portion of the water stop member 4, the water stop function between the housing 3 and the attachment target 10 can be ensured by the water stop member 4, and the water stop function of the water stop member 4 can be enhanced.

Next, connection of the terminal block 1 according to the present embodiment will be described.

The terminal block 1 according to the present embodiment is connected to the attachment target 10 by, for example, sequentially executing fitting of the water stop member 4 into the housing 3, fitting of the housing 3 into the attachment target 10, and fastening of the fastening member.

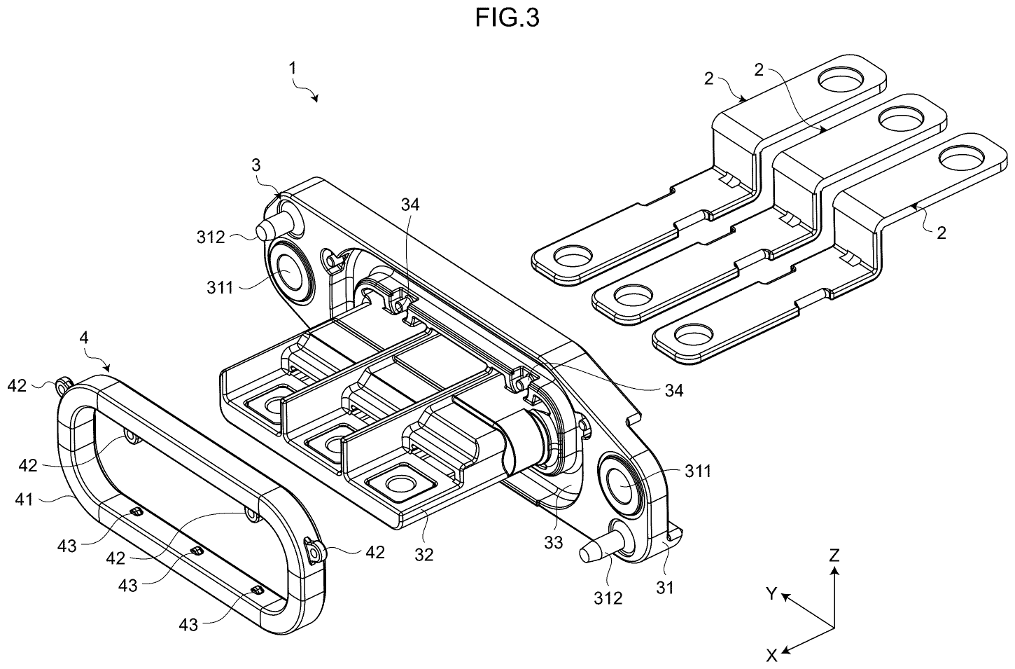

As illustrated in FIG. 3, fitting of the water stop member 4 is a process of attaching the water stop member 4 to the housing 3. That is, the water stop member 4 is fitted into the groove portion 33 of the housing 3. At this time, the water stop member 4 is fitted into the groove portion 33 such that the locking portions 42 engage with the pins 34. Therefore, the water stop member 4 is reliably fitted at a desired position with respect to the groove portion 33. In addition, as illustrated in FIG. 4, the water stop member 4 is attached to the housing 3 such that the locking portions 42 are disposed in the first region 91 and the protrusions 43 are disposed in the second region 92. In addition, at this time, since the protrusions 43 are formed only in the second region 92, the water stop member 4 is smoothly fitted.

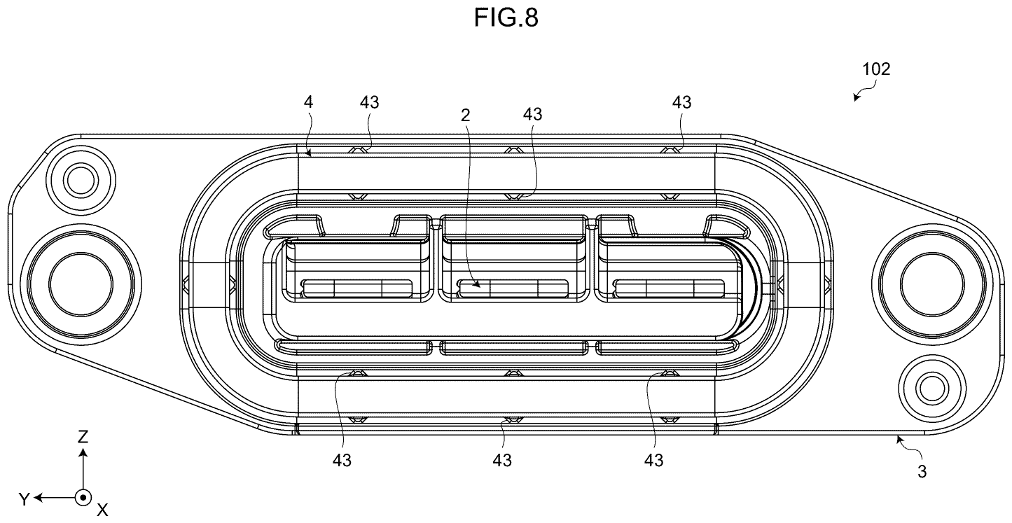

If the protrusions 43 are formed in the entire region of the water stop member 4 in a terminal block 102 as illustrated in FIG. 8, a strong force is required for fitting to the housing 3 in the entire region of the water stop member 4, and the water stop member 4 may not be smoothly fitted. On the other hand, in the terminal block 1 according to the present embodiment, the water stop member 4 can be smoothly fitted by forming the protrusions 43 only in the second region 92.

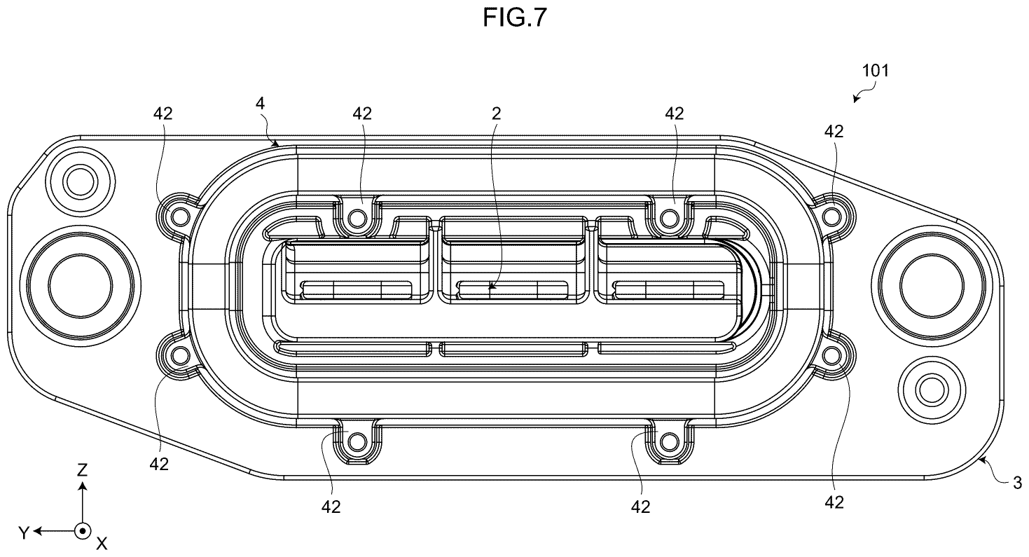

In addition, as illustrated in FIG. 7, if a terminal block 101 has the locking portions 42 formed in the entire region of the water stop member 4 and the protrusions 43 are not formed, the water stop member 4 can be smoothly fitted, but the water stop member 4 becomes large, and it becomes difficult to reduce the size of the terminal block 101. That is, since the locking portions 42 protrude outward, the installation range of the water stop member 4 increases, and the terminal block 101 increases in size. On the other hand, in the terminal block 1 according to the present embodiment, it is possible to reduce the size of the terminal block 1 by forming the locking portions 42 and the protrusions 43 in the water stop member 4 in different regions.

Then, when the fitting of the water stop member 4 is completed, the housing 3 is fitted to the attachment target 10 as illustrated in FIGS. 1 and 2. That is, the housing 3 is disposed with the protrusion portion 32 facing the attachment target 10, and is fitted to the attachment target 10 so as to insert the protrusion portion 32 into the fitting portion 11.

Then, the fastening member is fastened. The fastening member is inserted into the attachment hole 311 of the housing 3 and screwed into the attachment target 10 to fasten the housing 3 to the attachment target 10. At this time, in FIG. 4, the water stop member 4 contacts the attachment target 10 and is brought into pressure contact with the housing 3 and the attachment target 10. Therefore, the water stop member 4 applies the pressing force to the groove portion 33. In particular, as illustrated in FIG. 6, since the protrusions 43 make pressure contact with the sidewall 331 of the groove portion 33, the sidewall 331 receives the pressing force from the water stop member 4.

However, since the protrusions 43 are formed only in the second region 92, the pressing force applied to the sidewall 331 is alleviated as compared with the case where the protrusions 43 are formed in the entire region of the water stop member 4. That is, since the pressing force received in the second region 92 can escape to the first region 91 side, the load on the housing 3 is suppressed.

For example, as illustrated in FIG. 8, when the protrusions 43 are formed in the entire region of the water stop member 4, a strong pressing force is applied to the sidewall 331 of the groove portion 33 in the entire region of the water stop member 4. Therefore, a large stress is generated in the housing 3. On the other hand, in the terminal block 1 according to the present embodiment, by forming the protrusions 43 only in the second region 92, the pressing force of the water stop member 4 can be reduced, and the load on the housing 3 can be reduced.

When the fastening of all the fastening members is completed, the connection of the terminal block 1 according to the present embodiment to the attachment target 10 is completed.

As described above, in the terminal block 1 according to the present embodiment, the terminal block 1 can be reduced in size while reducing the pressing force of the water stop member 4 against the housing 3 by forming the locking portions 42 and the protrusions 43 on the water stop member 4.

In addition, in the terminal block 1 according to the present embodiment, by providing the locking portions 42 in the first region 91 of the water stop member 4 and providing the protrusions 43 in the second region 92 of the water stop member 4, it is possible to accurately reduce the size of the terminal block 1 while reducing the pressing force of the water stop member 4 against the housing 3.

In addition, in the terminal block 1 according to the present embodiment, the first region 91 is an upper region of the water stop member 4, and the second region 92 is a lower region of the water stop member 4, so that the pressing force of the water stop member 4 against the housing 3 can be reduced while ensuring the water stop function of the water stop member 4.

Note that the terminal block according to the present invention is not limited to the above-described embodiment, and various changes can be made within the scope described in the claims. The terminal block 1 according to the present embodiment may be configured by appropriately combining the constituent elements of each embodiment and the modifications described above.

For example, although the case where the terminal block 1 according to the above-described embodiment is mounted on a vehicle has been described, the terminal block 1 may be used without being mounted on a vehicle.

With the terminal block of the present embodiment, it is possible to reduce the pressing force of the water stop member against the housing and to reduce the size of the terminal block.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that holds a terminal; and
a water stop member that is accommodated in a groove portion formed on the housing and stops water between the housing and an attachment target, wherein
the water stop member includes a main body having an annular shape, a locking portion that protrudes from a side portion of the main body and is engaged with the housing, and a protrusion that protrudes from the side portion of the main body and contacts the groove portion.

2. The terminal block according to claim 1, wherein
the locking portion is provided in a first region of the water stop member, and
the protrusion is provided in a second region different from the first region of the water stop member.

3. The terminal block according to claim 2, wherein
the first region is a region located in an upper portion of the water stop member, and
the second region is a region located below the first region in the water stop member.
